(19) United States
(12) Patent Application Publication
(10) Pub. No.: US 2018/0014569 A1
(43) Pub. Date: Jan. 18, 2018

(54) PORTABLE DEPOSIT COMPARTMENT FOR WASTE COLLECTION

(71) Applicants: Alexandre Henrique Chagas Faresin, Londrina (BR); Fernando Favaretto Casaroli, Londrina (BR)

(72) Inventors: Alexandre Henrique Chagas Faresin, Londrina (BR); Fernando Favaretto Casaroli, Londrina (BR)

(21) Appl. No.: 15/650,675

(22) Filed: Jul. 14, 2017

Related U.S. Application Data
(60) Provisional application No. 62/362,123, filed on Jul. 14, 2016.

(51) Int. Cl. A24F 19/00; B65F 1/00

(52) U.S. Cl. CPC A24F 19/0064; B65F 1/0006; B65F 2240/14; B65F 2240/104

(57) ABSTRACT

The present invention relates to a bag design to receiving a by-product of a primary product, the bag comprising: a receptacle forming at least one interior compartment and formed from a unitary sheet, wherein an opening is formed to the at least one interior compartment, and a plurality of folding creases are disposed distal to the opening; an adhesive strip disposed on the exterior surface of the rear panel; a first portion of a locking mechanism disposed below the folding creases on the exterior surface of the front panel; a second portion of a locking mechanism disposed distal to the opening on the exterior surface of the rear panel and substantially aligned with the first portion of the locking mechanism.

### BACKGROUND

The present invention relates generally to containers, and more particularly to a container designed for receiving by-product of a primary product.

It is evident that the residues waste or by-product of primary products is one of the main producer of waste in urban areas, streets, parks, beaches and other areas frequently visited by people. Plastic caps, food wrappers, plastic bottles, and cigarette butts are scattered in the streets, all the way down to the shores of our oceans. These types of waste not only take many years to decompose, but they also pose as severe health hazard because of their toxic properties. In addition, the waste residue of primary products is extremely hard to manage after the have been discarded improperly on the ground. Once they touch the ground, the waste residue is at the mercy of weather conditions, turning the collection of these by-products into a more difficult and more expensive process.

The 850,000 tons of cigarette waste generated every year ranks first in the world ranking of most frequently discarded piece of litter in the environment double the amount of waste generated by the second place in the ranking, namely food packaging wraps, chewing gum, bottle caps and containers.

Cigarette manufacturers, regulatory government institutions, and even the smokers themselves did not assess the issue of discarding the butt as a crucial stage in the life cycle of the tobacco product. It is because of this lack of assessment and serious consideration that makes the current mechanisms of cigarette butt collection and treatment ineffective and almost obsolete, since seventy-seven percent (77%) of world's production of cigarette ends its trajectory in the oceans, rivers, lakes, and thus accumulating mountains of toxic waste that could take up to ten (10) years to decompose.

It is well known that many people smoke cigarettes and have no place to put the cigarette butts or trash from the cigarette packaging because of the lack of abundance of disposal bins. With regards to cigarettes in particular, the smoker lights and then smokes the consumable tobacco portion of the cigarette by inhaling the lit tobacco through the non-consumable filter portion of the cigarette. When the smoker is finished smoking the cigarette, which may be before the consumable portion is entirely consumed, he or she must extinguish the cigarette. The non-consumed portion of the cigarette is commonly referred to as the cigarette butt. Because the butt portion of the cigarette is not consumed during the smoking process, the user must dispose of the butt.

In general, smokers tend to be more environmental conscientious while attending places with higher rates of preservation. On those occasions, smokers go as far as storing butts inside beverage cans, empty pack of cigarettes, and even making piles of butts on the beach's sand to be properly discarded later. In contrast, the same smokers are strikingly more inclined to discard their butts on the ground while attending places in urban and metropolitan areas. Evidently, these smokers have a false perception about the true negative impact that butts have on the environment, A cigarette butt discarded in metropolitan and urban areas damages the environment just as much as a cigarette butt discarded on the beach, parks, or any other preserved area. In addition, most urban and metropolitan areas simply do not have enough stationary trashcans and butt collectors distributed to sustain the demand and needs of the smokers.

The proliferation of cigarette butts being disposed in improper places is well known, indicating the severity of the problem of being able to find a proper disposal location. Although most smokers will dispose of a cigarette butt in an ashtray or like device if it is readily available, such as an automobile ashtray, the problem of disposal arises when such devices are not readily available. Because the butt was lit and is subject to breaking apart and spreading ash smokers tend to not want to place the butt in a pocket of their pants, shirt, jacket or other clothing. Likewise, many smokers are concerned with throwing a cigarette butt, even if believed to be properly extinguished, in a combustible trash container or a trash container having other combustible materials therein. As such, many smokers may consider it to be safer and more convenient to simply drop or throw the cigarette butt on the ground, particularly if it is a hard surface such as asphalt or concrete. In fact, dropping the butt on the ground and then grinding it with one's shoe or boot appears to be a common way of collectively extinguishing and disposing of the butt. While it is effective, from certain viewpoints, it is unsightly and contributes to pollution and overall environmental degradation.

Altogether, the lack of assessment on the issue of discarding the butt by not treating it as a crucial stage on the life cycle of the product leads to a poorly design solution such as the stationary (fixed) points of butt collection or trash bins that fails to take into consideration the habits and needs of the smokers (users).

Therefore, it is desired to have a device that is small, compact, and odor free to dispose of the cigarette butts, and the other small waste by-products produced by many of the products people carry around with them.

### SUMMARY

Aspects of an embodiment of the present invention disclose an apparatus that addresses the difficulties in disposing of by-product waste from primary products. The invention has distinct features allow a user of the primary product to easily, discreetly dispose of the by-product waste.

An embodiment of the present invention disclosed a disposal, portable, and pocketable bag for receiving a by-product waste of a primary product, the bag comprising a unitary sheet having an exterior surface and an interior surface, and the unitary sheet having a front panel, a first side panel, a second side panel, and a rear panel, wherein the front panel has a plurality of creases and the rear panel has a plurality of creases, an adhesive strip disposed on the exterior surface of the rear panel, a first portion of a locking mechanism disposed below the plurality of creases on the exterior surface of the front panel, and a second portion of a locking mechanism disposed on the rear panel.

A flexible and disposable container for receiving a by-product waste of a primary product, the container comprising a front panel having a first edge, a second edge, and a third edge, wherein the first edge and the second edge are opposite one another, a first side panel attached to the first edge of the front panel, a second side panel attached to the second edge of the front panel, a rear panel attached to the third edge of the front panel, an adhesive strip disposed on the rear panel, a first portion of a locking mechanism disposed on the front panel, and a second portion of a locking mechanism disposed on the rear panel.

A flexible and disposable container for receiving a by-product waste of a primary product, the container comprising a plurality of sheets adhered together, wherein the plurality sheets form a unitary cutout with a front panel, a first side panel, and a second side panel, and a rear panel wherein the first side panel and the second side panel are on opposite sides of the front panel and a rear panel extending front the front panel, further the front panel has a first plurality of creases distal to the end which is opposite where the rear panel extends away from the front panel and the rear panel has a second plurality of creases distal to the end which is not in contact with the front panel, an adhesive strip disposed on the rear panel, a first portion of a locking mechanism disposed on the front panel distal to the first plurality of creases, and a second portion of a locking mechanism disposed on the rear panel distal to the second plurality of creases and substantially aligned with the first portion of the locking mechanism.

### BRIEF DESCRIPTION OF SEVERAL VIEWS OF THE DRAWINGS

FIG. 1 depicts a diagram of an unfolded disposal bag, in accordance with one embodiment of the present invention.

FIG. 2 depicts a diagram of a closed disposal bag, in accordance with one embodiment of the present invention.

FIG. 3 depicts a diagram of a partially closed disposal bag, in accordance with one embodiment of the present invention.

FIG. 4 depicts a diagram of an open disposal bag, in accordance with one embodiment of the present invention.

FIG. 5 depicts a diagram of the closed disposal bag attached to a primary product, in accordance with one embodiment of the present invention.

### DETAILED DESCRIPTION

As will be appreciated by one skilled in the art, aspects of the present invention may be embodied as a disposable container for waste products such as bottle caps, gum wrappers, cigarette butts, or other small waste by-products that tend to get thrown or left in the street from the primary products used by people. For example, the cigarette butts from cigarettes, or the gum wrappers from packs of gum. Embodiments of the present invention disclose an approach to solve the issue of not having a convenient and easy container to dispose of these by-products.

The present invention may also be used as a container to hold the by-product until a large trash bin or waste reciprocal is found. In some embodiments, the present invention is designed to omit the odor of the waste material inside, so that the person holding the container and the people around the person are not exposed to the odor of the contents. The present invention may be various sizes and shapes based on the intended primary product and the by-product created by the primary product. For example, if it is designed for cigarette butts, it will be similar dimensions to the cigarette pack, or if is designed for gum wrappers, it will be sized a similar size as the pack of gum.

The present invention will now be described in detail with reference to the Figures.

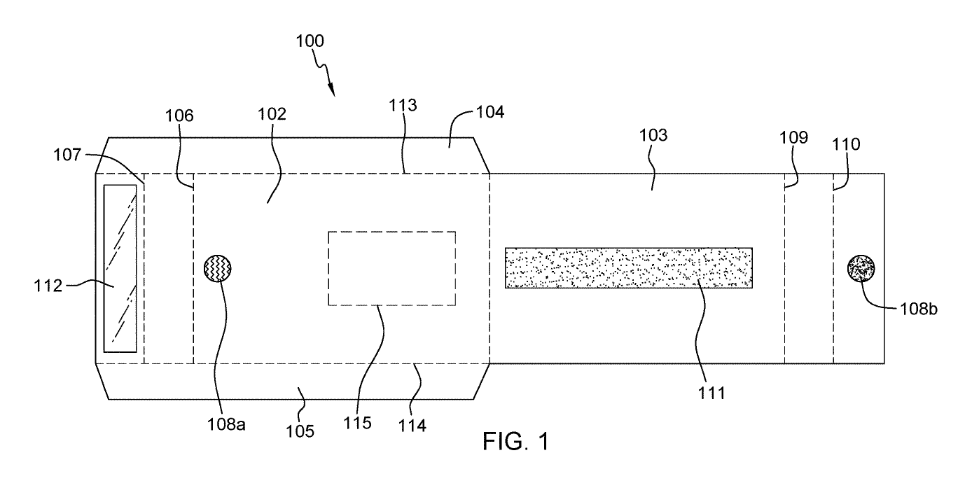

FIG. 1 depicts a diagram of an unfolded disposal bag 100, in accordance with one embodiment of the present invention. The disposal bag 100 is cut or stamped out and scored with fold lines from a single sheet of material. In additional embodiments, the disposal bag 100 may be comprised of multiple sheets adhered or affixed together. In some embodiments, the paper has a fire-resistant or fire-retardant coating on one or both sides. The disposal bag 100 may be made from a single piece of material, or may have multiple layers that are adhered together. The disposal bag 100 can be paper or other desired materials. Preferably the material(s) that are used on the disposal bag 100 are biodegradable. In one embodiment, the material used is a two-ply paper that is laminated or coated with metal foil which is both heat resistant and non-combustible, such as an aluminum foil. Additionally, a separate thin film of metallic (i.e., aluminum foil) or composite lining can be used to provide a non-combustible interior for the disposal bag 100. Use of a non-combustible interior for the disposal bag 100 will contain the heat from the cigarette butts that are placed inside the disposal bag 100 and prevent the disposal bag 100 from catching on fire. In addition to providing temperature and fire protection, the material will also provide disposal bag 100 that will resist tearing or otherwise undesirable openings forming that could result in the contents being spilled.

The disposal bag 100 has a front panel 102, a rear panel 103, a side panel 104, and a side panel 105. The side panels 104 and 105 extend from the front panel 102. In the depicted embodiment, side panel 104 has a crease 113 to assist in the assembly process, and side panel 105 has a similar crease 114 separating the side panels from the front panel 102. In additional embodiments where the disposal bag 100 is comprised of several separate panels, the crease lines 113 and 114 may not be present. The side panels 104 and 105 may adhere to the rear panel 103 by an adhesive material such as tape or glue, or they may be welded, fused, or sealed together to form a substantially airtight and/or water tight interior compartment. The interior compartment may have dividers or separates inside to assist in organizing or sectioning of certain types of by-products placed inside the disposal bag 100. In some embodiments, the seal between the side panels 104 and 105 and the rear panel 103 is able to stand the heat that would be created by a still burning cigarette. The seal will also be able to substantially contain any moisture or liquid inside. In the depicted embodiment, the disposal bag 10 is rectangular. As known to one skilled in the art, the disposal bag 100 may be various shapes. In an embodiment, the interior surface of the front, rear, and side panels 102, 103, 104, and 105 respectively are coated in a flame retardant material to reduce the possibility of the disposal bag 100 becoming enflamed.

On the front panel 102 there are a first fold 106 and a second fold 107. These folds may be pre-folded or creased into the sheet during production or may be referenced by a visual cue for the user. These folds are designed so that when the user is closing the disposal bag 100, the two portions of a lock line up and allow the user a more desirable experience with the disposal bag 100. In additional embodiments, there may be more or less folds. The lock is used to secure the open end of the disposal bag 100 in a closed position to keep the contents within the disposal bag 100. On the front panel 102 a first portion 108a of the lock is secured in a predetermined location. In the depicted embodiment, this location is substantially in the center of the front panel 102 down it's center line. In the depicted embodiment, the first portion 108a of the lock is positioned below the second fold 107. The lock may be a hook and loop style fastener, a resealable adhesive, or other types of releasable locks that are able to be opened and closed numerous times. In some embodiments, the lock is disposed along the opening of the disposal bag 100 and is a zip-top seal, or a press seal. The lock is designed to seal the disposal bag 100 shut and contain the materials inside. Ideally keeping any odor of the contents from leaking out as well.

In additional embodiments, the front panel 102 may have a semi-circular cutout that extends through the folds 107 and 106 to allow a wider opening when the disposal bag 100 is constructed. The cutout allows for additional area which the user has exposed to the interior compartment of the disposal bag 100. In additional embodiment, the cutout may have various shapes and depths to accommodate various by-products which are design to be placed in the disposal bag 100. In the embodiments where the cutout is present, the scoring mechanism 112 may be removed or there may be more than one scoring mechanism 112.

In additional embodiments, an adhesive pad 115 may be affixed on the front panel 102 so that the user can stick smaller pieces of trash or by-product (e.g. gum wrappers or chewing gum to the adhesive pad 115, so that the user does not have to continuously open the disposal bag 100. The adhesive pad 115 may have a resealable plastic cover (not shown) so that the adhesive pad 115 does not become degraded with dirt and dust. The plastic cover will be secured on at least one side, while the other sides would be easily pulled apart from the adhesive pad 115. In additional embodiments, the adhesive pad does not have a cover and exposed to the elements. This adhesive pad 115 may be affixed to various predetermined locations on the front panel 102 or even the rear panel 103. The size and adhesive properties may be modified based on the intended operation or usage of the disposal bag 100.

On the rear panel 103 there is a first fold 109 and a second fold 110 which align substantially with the first fold 106 and the second fold 107 of the front panel 102. These folds may be pre-folded or creased into the sheet during production or may be referenced by a visual cue for the user. A second portion 108b of the lock is adhered to the rear panel 103 in a similar fashion as the first portion 108a. In the depicted embodiment, the second portion of the lock is positioned above the first fold 109. This positioning of the second portion 108b is designed, so that when the disposal bag 100 is folded along the first fold (106 and 109) and again along the second fold (107 and 110), the first portion 108a and the second portion 108b of the lock will substantially aligned and the user can seal the disposal bag 100 shut. In instances where, the edge of the opening has a zip-top closing mechanism, the lock portions 108a and 108b may still be employed to assist in reducing the overall size of the disposal bag 100. The disposal bag 100 is designed to be small and unobtrusive to the user to reduce the likelihood that the user will not use the disposal bag 100 because it becomes an annoyance or an eye sore.

Additionally, the rear panel 103 has an attachment means 111 which is used to secure the disposal bag 100 to another object. The attachment means 111 is an adhesive strip that is used to attach the disposal bag 100 to a wall, cigarette box, car dashboard, or any relatively flat surface. In the depicted embodiment, the attachment means 111 is a narrow strip that extends a predetermined distance from the top of the rear panel 103 and produced adequate adhesion to a surface so that even if the disposal bag 100 is full, it will still stick to the surface. In an embodiment, the attachment means 111 has a cover (not shown) that is easily removable and is used to protect the attachment means 111 until the user is ready to attach the disposal box 100 to the surface of their choice. This cover is also used to keep the disposal bags 100 from sticking together while shipping or in storage.

A scoring mechanism 112 is shown affixed to the front panel above the fold 107 and the top edge of the disposal bag 100. The scoring mechanism 112 allows the user to extinguish a cigarette butts directly on the disposal bag 100. The scoring mechanism 112 may be one piece of rough material such as sandpaper or sandpaper-like material. In additional embodiment, the scoring mechanism 112 may be affixed to the disposal bag 100 in a plurality of other locations, and may have various sizes and shapes as well. In the depicted embodiment, the scoring mechanism 112 is affixed to the front panel 102 between the first fold 106 and the second fold 107 so as to not interfere with the lock, but also so that when the disposal bag 100 is “closed” the scoring mechanism 112 is covered so as to not get any ash, embers, or dirt on the user if they put the disposal bag 100 in their pocket or pants. The scoring mechanism 112 may be adhered to the disposal bag 100 through the use of an adhesive, or other method of attachment. Due to the scoring mechanism 112 being a stronger material, it also assists in keeping the disposal bag 100 rigid, so as to add stiffness such that when the disposal bag 100 is folded it can be easily slid into a cigarette packaging without damaging the disposal bag 100 or the cigarettes. It also assists the user when the disposal bag 100 is unfolded to keep the open end, open wide so the user may easily place the by-product inside. The scoring mechanism 112 should be suitable for permitting a smoker to rub or crush his or her cigarette against so as to extinguish the cigarette butt to allow the user to safely store the butt inside and configured to prevent damage to disposal bag 100 from the lit cigarette butt and/or the rubbing or crushing action to extinguish the cigarette butt.

In certain embodiments, there is a need to help with the prevention of heat or fire damage to the disposal bag 100 or more importantly to the user or the environment. Thus, a non-combustible sheet, material, or coating may be added behind or around the edges of the scoring mechanism 112 so that any hot coals will not be able to ignite the unprotected area of the disposal bag 100. This may be a thin strip of metallic material or similar non-combustible materials or coatings that may or not be used to coat the internal compartment. This non-combustible feature may also provide further structural support and add additional stiffness to the disposal bag 100.

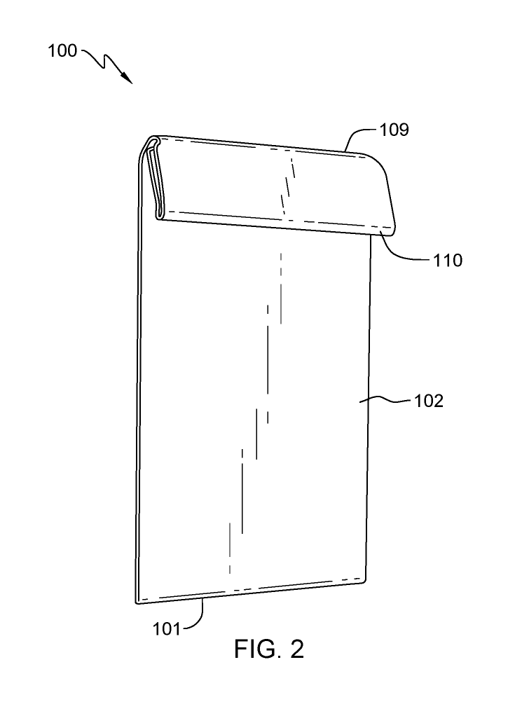

FIG. 2 depicts a diagram of a closed disposal bag 100, in accordance with one embodiment of the present invention. In the depicted embodiment, the disposal bag 100 is constructed and the panels are sealed together. The bottom end 101 is shown sealed shut and is substantially air and water tight, and the top end is folded shut and the lock portions 108a and 108b are secured together substantially concealing the contents of the disposal bag 100 inside. In the depicted embodiment, the front panel 102 is shown with the adhesive pad 115. The completely closed disposal bag 100 is secured shut by the lock, the scoring mechanism 112 is sealed away to reduce any ash or by-product rubbing against the user's clothes or another surface, and the bi-fold closing mechanism provides additional security that odors will not escape the disposal bag 100. The odor sealant is increased by the type of material used, and if a flame retardant or water proof seal are used to coat the internal or external surface of the disposal bag 100.

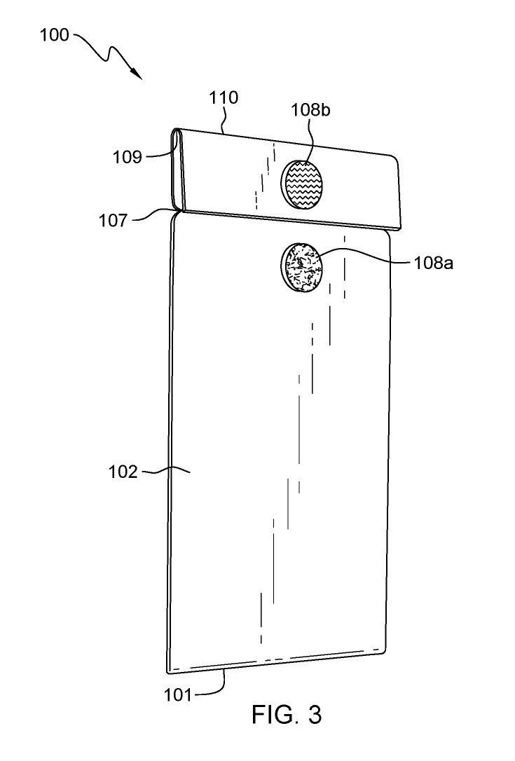

FIG. 3 depicts a diagram of the partially closed disposal bag 100, in accordance with one embodiment of the present invention. A first section of the disposal bag 100 is shown folded down along fold lines 107 and 110, but fold lines 106 and 109 have not been folded closed, thereby closing off the internal compartment of the disposal bag 100, but leaving the lock portions 108a and 108b exposed. The bi-folding method of sealing the disposal bag 100 provides additional security that if the disposal bag 100 is bumped or moves around with the user's pocket that it is unlikely to completely open without the user becoming aware. As is shown, the first portion 108a and the second portion 108b of the lock are substantially aligned and ready to securely seal the internal compartment of the disposal bag 100.

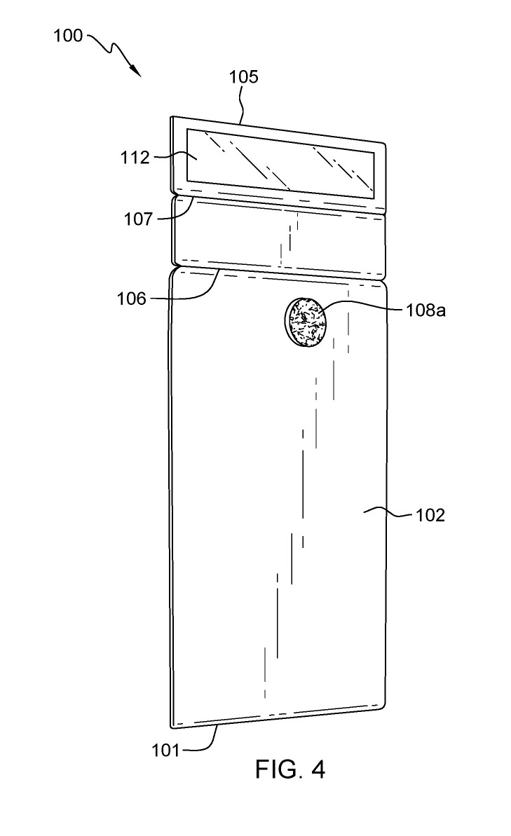

FIG. 4 depicts a diagram of the open disposal bag 100, in accordance with one embodiment of the present invention. The front panel 102 and the first fold 106, the second fold 107, the first portion of the locking mechanism 108a, and the scoring mechanism 112 are all exposed. The top end 105, where the opening to the internal compartment is located is accessible.

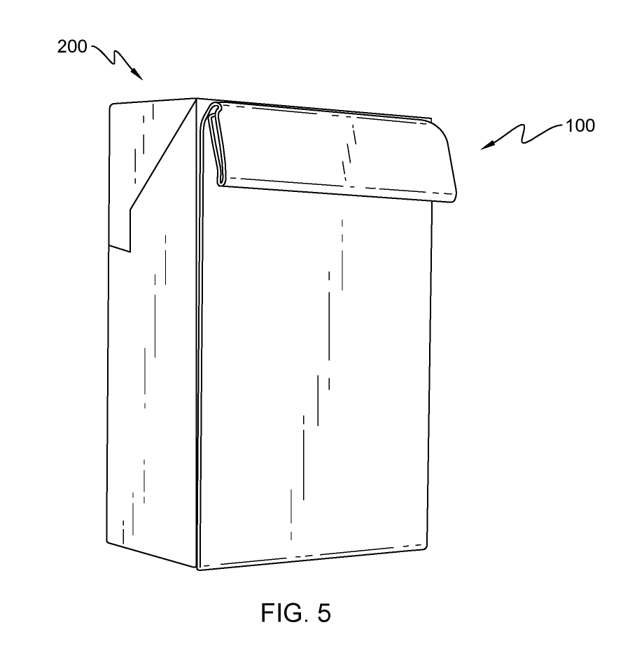

FIG. 5 depicts a diagram of the closed disposal bag 100 attached to a primary product 200, in accordance with one embodiment of the present invention. The primary product 200 in the depicted embodiment is a cigarette pack. The disposal bag 100 is attached to the primary product 200 via the attachment means 111. It is shown how the disposal bag 100 when closed is substantially the same dimensions as the primary product 200. In additional embodiments, the disposal bag 100 may have varying dimensions based on the dimensions of the primary product 200, and the size of the by-product of the primary product 200. This design where the primary product 200 and the disposal bag 100 are similar dimensions creates a device that is less obtrusive to the user and the user is more likely to carry with them or use.

In certain geographical areas, recycling efforts specifically aimed at recycling cigarette butts have been developed to reduce the amount of environmental contamination caused by the improper disposal of cigarette butts, bottle caps, gum wrappers, and other small by-products. It is possible that such recycling efforts would not include the recycling of the disposal bag 100 with the cigarette butts. Therefore, to facilitate these recycling efforts, the disposal bag 100 is easily emptied out through the opening at the top end 105. The material the disposal bag 100 is made out of is preferably recyclable material to further assist in the recycling efforts around the world.

In some embodiments, the disposal bag 100 has a perforated section, so that the disposal bag 100 can be quickly opened even when in the closed position to allow the user an even quicker way to open the disposal bag 100 and dump out the contents. This perforation would likely extend around the entire disposal bag and be positioned below the first portion 108a of the lock 108 towards the bottom end 101.

In use, the disposal bag 100 will either be sold with the primary product 200 which produces the by-product, such as, cigarette packs, cartons, gum packages, soda or beer bottles, or may be individually sold to encourage people to safely and responsibly dispose of their waste without throwing it on the ground. For example, the smoker will remove the disposal bag 100 from the cigarette carton or pack and either attach it to the carton, pack, or to the surface that is most convenient for them. When the cigarette is smoked down to the butt or the smoker is otherwise finished with the cigarette, the smoker will open the disposal bag 100 and crush the butt on the mechanism 112 and then place the extinguished butt in the disposal bag 100, and reclose the disposal bag 100 and engaging the lock 108. When the lock 108 is engaged the odors from the butts is less likely to escape and assists in creating a pleasant environment for the smoker and those around them. With the disposal bag 100 the user is able to easily and hygienically disposed of their waste. In this manner, there is no need to touch or otherwise physically handle the by-product, and instead the user only needs to interact with the clean, compact, and visually appealing disposal bag 100. Thus, in the instance with the smoker providing a nicer cleaner smoking experience, but also providing all other users of the disposal bag 100 a cleaner, simpler experience to keep their trash off the ground and out of the water, thereby helping to keep our cities and neighborhoods clean.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape and use.

What is claimed is:

1. A disposal, portable, and pocketable bag for receiving a by-product waste of a primary product, the bag comprising:
a unitary sheet having an exterior surface and an interior surface, and the unitary sheet having a front panel, a first side panel, a second side panel, and a rear panel, wherein the front panel has a plurality of creases and the rear panel has a plurality of creases;
an adhesive strip disposed on the exterior surface of the rear panel;
a first portion of a locking mechanism disposed below the plurality of creases on the exterior surface of the front panel; and
a second portion of a locking mechanism disposed on the rear panel.

2. The disposal bag for receiving waste products of claim 1, wherein the unitary sheet is formed from a plurality of layers.

3. The disposal bag for receiving waste products of claim 1, wherein the first portion of the locking mechanism and the second portion of the locking mechanism are substantially aligned.

4. The disposal bag for receiving waste products of claim 2, wherein one of the plurality of layers is a substantially heat resistant material.

5. The disposal bag for receiving waste products of claim 1, wherein the locking mechanism is a hook and loop style fastener.

6. The disposal bag for receiving waste products of claim 1, wherein the first and second side panels are on opposing side of the front panel.

7. The disposal bag for receiving waste products of claim 1, further comprising a patch of rough material disposed between the folding creases, so when the lock is engaged the patch of rough material is sealed within the folds.

8. The disposal bag for receiving waste products of claim 6, further comprising a substantially heat resistant material lining the edges of the patch of rough material.

9. The disposal bag for receiving waste products of claim 6, wherein the rough patch of material is similar to sand paper.

10. The disposal bag for receiving waste products of claim 1, further comprising a zip-top disposed within the interior compartment distal to the open end of the interior compartment and permits a substantially air tight and water tight seal to be made between the interior compartment and the environment.

11. The disposal bag for receiving waste products of claim 1, further comprising a divider within the interior compartment to section of the interior compartment.

12. The disposal bag for receiving waste products of claim 1, further comprising an adhesive pad affixed to a predetermined location on the front panel.

13. The disposal bag for receiving waste products of claim 11, further comprising a plastic cover affixed to one edge of the adhesive pad and substantially covers the adhesive pad and is resealable to the adhesive pad.

14. The disposal bag for receiving waste products of claim 1, further comprising a perforated section, wherein the disposal bag can be torn in two along the perforated section.

15. The disposal bag for receiving waste products of claim 1, wherein the patch of rough material provides additional structural rigidify.

16. A flexible and disposable container for receiving a by-product waste of a primary product, the container comprising:
a front panel having a first edge, a second edge, and a third edge, wherein the first edge and the second edge are opposite one another;
a first side panel attached to the first edge of the front panel;
a second side panel attached to the second edge of the front panel;
a rear panel attached to the third edge of the front panel;
an adhesive strip disposed on the rear panel;
a first portion of a locking mechanism disposed on the front panel; and
a second portion of a locking mechanism disposed on the rear panel.

17. A flexible and disposable container for receiving a by-product waste of a primary product, the container comprising:
a plurality of sheets adhered together, wherein the plurality sheets form a unitary cutout with a front panel, a first side panel, and a second side panel, and a rear panel wherein the first side panel and the second side panel are on opposite sides of the front panel and a rear panel extending front the front panel, further the front panel has a first plurality of creases distal to the end which is opposite where the rear panel extends away from the front panel and the rear panel has a second plurality of creases distal to the end which is not in contact with the front panel;
an adhesive strip disposed on the rear panel;
a first portion of a locking mechanism disposed on the front panel distal to the first plurality of creases; and
a second portion of a locking mechanism disposed on the rear panel distal to the second plurality of creases and substantially aligned with the first portion of the locking mechanism.
